(19) United States
(12) Patent Application Publication
(10) Pub. No.: US 2025/0356034 A1
(43) Pub. Date: Nov. 20, 2025

(54) DYNAMIC CONTENT SHARING

(71) Applicant: CITRIX SYSTEMS, INC., Fort Lauderdale, FL (US)

(72) Inventors: DAN HU, NANJING (CN); ZE CHEN, NANJING (CN); ZONGPENG QIAO, NANJING (CN)

(21) Appl. No.: 18/874,448

(22) PCT Filed: Sep. 29, 2022
(86) PCT No.: PCT/CN2022/122517

§ 371 Date: Dec. 12, 2024

(51) Int. Cl. G06F 21/60; G06F 9/451; G06F 21/84

(52) U.S. Cl. CPC G06F 21/604; G06F 9/451; G06F 21/84

(57) ABSTRACT

Methods and systems for sharing content is described herein. Based on receiving input associated with sharing portions of content displayed on a presenter screen, shared content data associated with sharing the portions of content may be generated. Based on the shared content data, a shared content indicator may be updated to indicate the portions of content to share. A screen capture based on the presenter screen may be generated. Screen data including the portions of content and a mask that covers regions of the screen capture that are not occupied by the portions of content may be generated. Furthermore, the computing device may send the screen data to remote computing devices that are configured to generate audience screens based on the screen data.

### FIELD

Aspects described herein generally relate to computer networking, remote computer access, virtualization, enterprise mobility management, screen sharing, and hardware and software related thereto. More specifically, one or more aspects describe herein provide platform agnostic systems for dynamically sharing content.

### BACKGROUND

Screen sharing applications in which screens of participants may be shared with other participants are increasingly popular. Screen sharing may be used by participants to share the contents of a user's computing device with other users. However, certain screen sharing applications are lacking in terms of ease of use and the ability to protect confidential information. As such, there exists a demand for an improved way to share screen content with other users.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Sharing content during a screen sharing session may be suboptimal due to the limitations of the particular screen sharing application being used. In some cases, it is inconvenient for a user to share more than one portion of content and the content presented to other users may appear jumbled. Further, the process of sharing content may be inconvenient and may require a user to use excessive time and effort when selecting content to share. Additionally, a user that is sharing content may not want other users to see other content that is not being shared, but which may be visible in the background of the shared screen. To overcome limitations in the prior art described above, and to overcome other limitations that will be apparent upon reading and understanding the present specification, aspects described herein are directed towards dynamic content sharing.

In some examples, a computing device may, based on receiving input associated with sharing one or more portions of content displayed on a presenter screen, generate shared content data associated with sharing the one or more portions of content. The computing device may update, based on the shared content data, a shared content indicator to indicate the one or more portions of content to share. The computing device may generate a screen capture based on the presenter screen. The computing device may generate screen data comprising the one or more portions of content and a mask that covers regions of the screen capture that are not occupied by the one or more portions of content. Furthermore, the computing device may send the screen data to one or more remote computing devices that are configured to generate one or more audience screens based on the screen data.

In some examples, the screen data may be sent via an instance of a collaboration application executed on the computing device. Further, one or more instances of the collaboration application may be executed on the one or more remote computing devices.

In some examples, one or more positions of the one or more portions of content within the screen capture correspond to one or more positions of the one or more portions of content within the presenter screen.

In some examples, an overlap of each portion of the content with respect to other portions of the content is based on an order in which each portion of the content was selected for sharing.

In some examples, a portion of content that was most recently added to the shared content data overlaps other portions of the content within the screen capture.

In some examples, the shared content indicator comprises a window comprising one or more icons associated with the one or more portions of content.

In some examples, the input associated with sharing content displayed on a presenter screen may comprise dragging the one or more portions of content into the shared content indicator.

In some examples, the input associated with sharing content displayed on a presenter screen may comprise adding one or more application icons corresponding to the one or more portions of content to the shared content indicator.

In some examples, the computing device may generate, within a shared content indicator, one or more application icons corresponding to one or more applications that execute applications associated with the one or more portions of content that are shared.

In some examples, based on receiving input associated with removing an application icon associated with one or more portions of content from the shared content indicator, removing the one or more portions of content from the presenter screen.

In some examples, dimensions of at least one of the one or more audience screens correspond to dimensions of the presenter screen.

In some examples, the screen data may indicate where to mask the regions of the screen capture that are not occupied by the one or more portions of content that are shared.

In some examples, the presenter screen may be generated by a virtual sharing application executed on a virtualization system.

In some examples, one or more positions of the one or more portions of content are based on dimensions of the one or more portions of content.

In some examples, based on receiving input associated with stopping the sharing of one or more portions of content, removing the one or more portions of content from the shared content data and the presenter screen.

In some examples, based on receiving input associated with moving content that is shared within the presenter screen, updating the mask to cover the regions of the screen capture that were previously occupied by the one or more portions of content that are shared.

In some examples, the mask comprises a blurred image based on the regions of the screen capture that are not occupied by the one or more portions of content.

In some examples, the shared content indicator comprises a window comprising a list of content based on the one or more portions of content.

Corresponding apparatuses, devices, systems, and computer-readable media (e.g. non-transitory computer-readable media) are also within the scope of the disclosure.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts a diagram of a user interface for dynamic content sharing in accordance with one or more aspects of the present disclosure.

FIG. 6 depicts a diagram of a mask used for dynamic content sharing in accordance with one or more aspects of the present disclosure.

FIG. 7 depicts a platform architecture for a dynamic content sharing system that may be used in accordance with one or more aspects described herein.

FIG. 8 depicts a platform architecture for a dynamic content sharing system that may be used in accordance with one or more aspects described herein.

FIG. 9 depicts a flowchart showing an example method for dynamic content sharing in accordance with one or more aspects of the present disclosure.

FIG. 10 depicts a flowchart showing an example method for dynamic content sharing in accordance with one or more aspects of the present disclosure.

FIG. 11 depicts a schematic representation of data movement for transmission of screen data.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed to sharing screen content and in particular to dynamically sharing content displayed on a presenter's computing device. A user may execute an instance of the disclosed technology on a computing device (e.g., a user's tablet computing device) and receive inputs from the user to determine content of the presenter's screen that will be shared with other users. In particular, information associated with the content may be added to screen data, the remaining regions of the presenter's screen may be covered, and the screen data may then be shared with other users. Further, information associated with the content may be added to the screen data via a user friendly interface in which a user may simply drag content the user wishes to share to a shared content indicator (e.g., a shared content window) that is associated with the shared content data, and which may be used to automatically add the content to the screen data. Additionally, the disclosed technology may automatically generate a mask that covers any content that a presenter may not intend to share. In this way, the disclosed technology provides various technical effects and benefits including more effective screen sharing, protection of user privacy, improved case of use, and a reduction in usage of computational resources due to more selective sharing of content.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

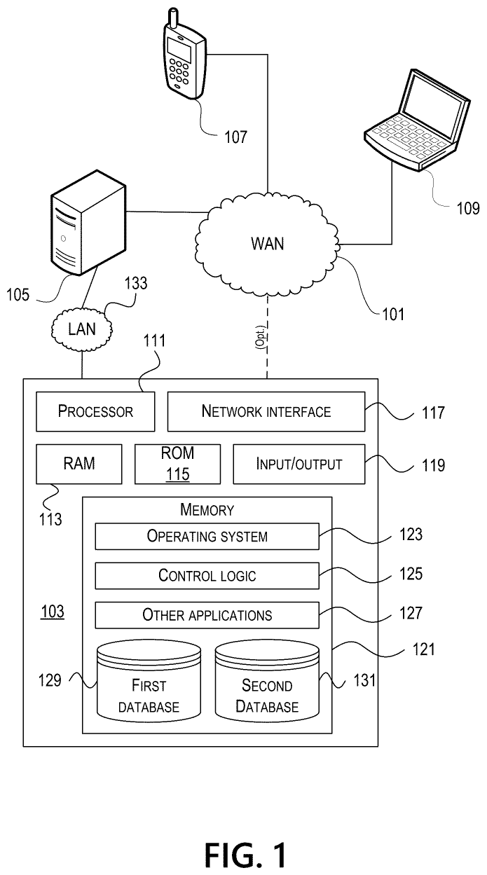

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

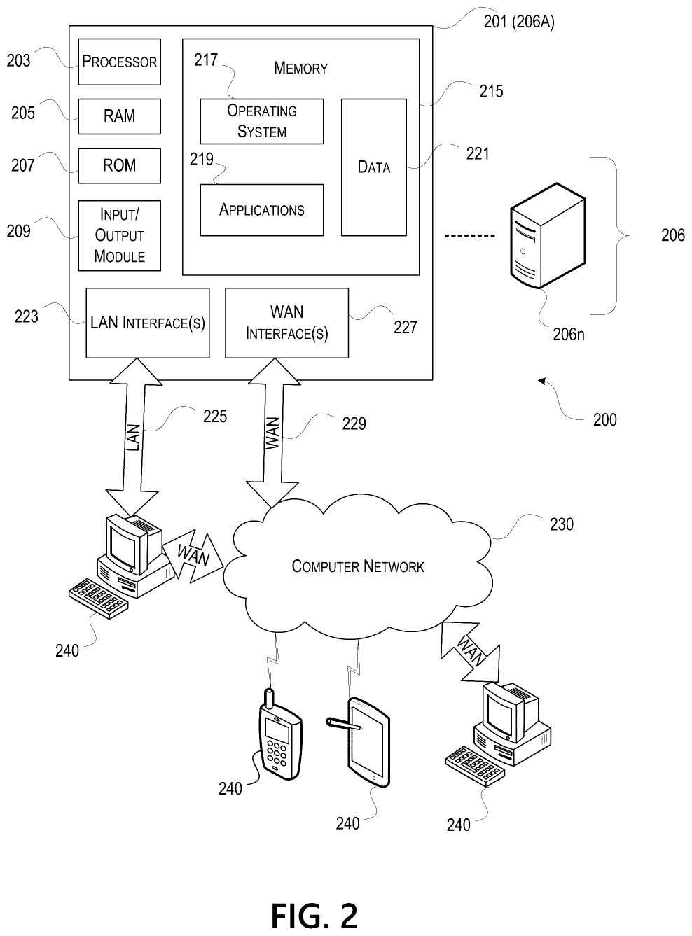

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over the computer network 230, e.g., network 101.

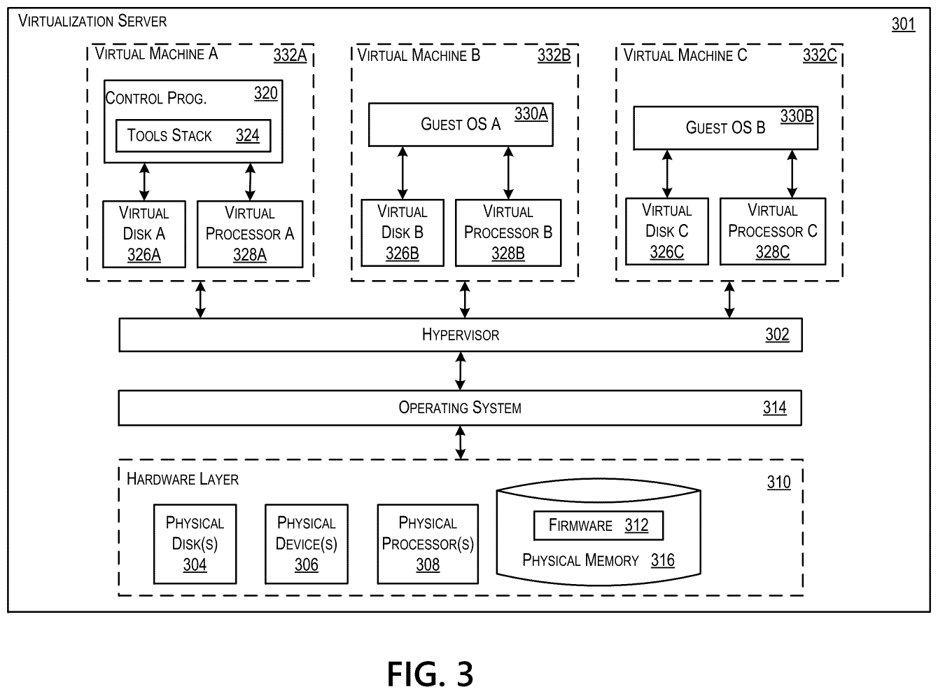

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

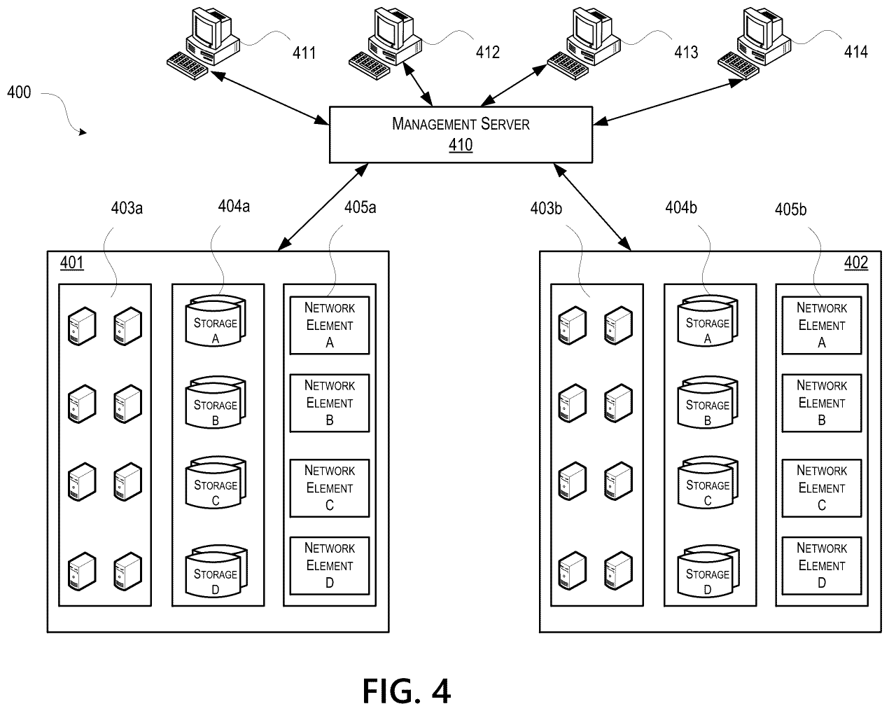

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Washington), AMAZON EC2 (Amazon.com Inc. of Seattle, Washington), IBM BLUE CLOUD (IBM Corporation of Armonk, New York), or others.

### Dynamic Content Sharing System

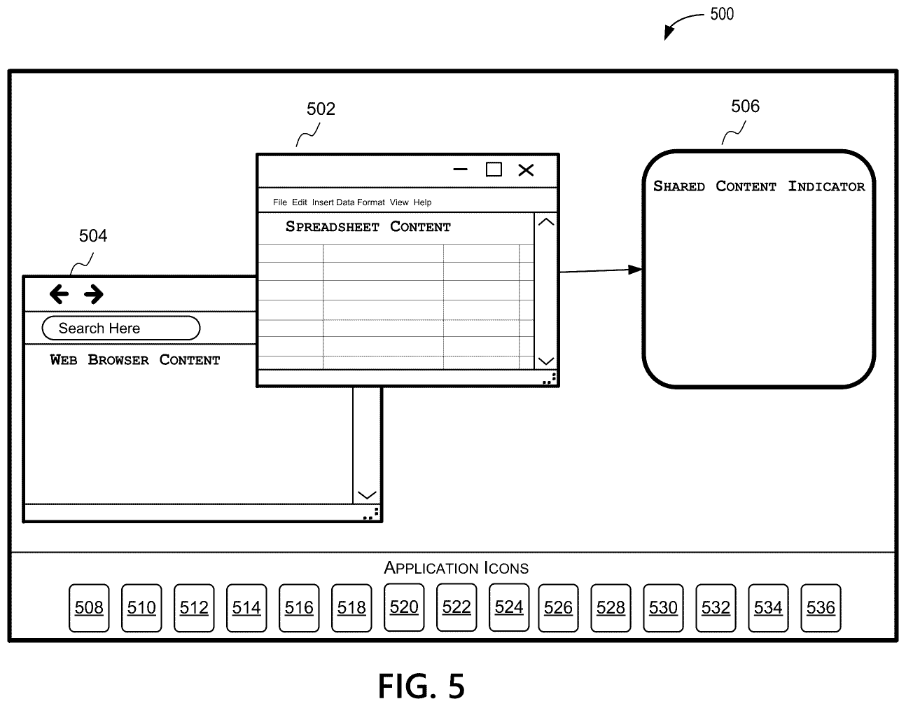

FIG. 5 depicts an example of implementing a dynamic content sharing system in accordance with the present disclosure. The applications and operations described herein may be implemented or performed, for example, by one or more of the systems discussed with respect to FIGS. 1-4. The presenter screen 500 may be comprise content comprising content 502 (e.g., a spreadsheet window), content 504 (e.g., a web browser window), a shared content indicator 506, and a plurality of application icons 508-536. The presenter screen 500 may be implemented on a local computing device of a presenter or in a virtual desktop that is remote from the local computing device of the presenter. For example, the presenter screen 500 may be generated in a virtual desktop of a remote computing device and accessed via a client application that is executed on a local computing device of the presenter. The client application may then obtain access and control over the virtual desktop hosted on a remote computing device.

The content 502 may be shared with other computing devices by dragging the content 502 to the shared content indicator 506. Further, the content 502 may be an instance of an application corresponding to the application icon 508. When the content 502 is added to the shared content indicator 506, a representation of the application icon 508 may be generated within the shared content indicator 506 to indicate that content of the application corresponding to the content 502 is being shared.

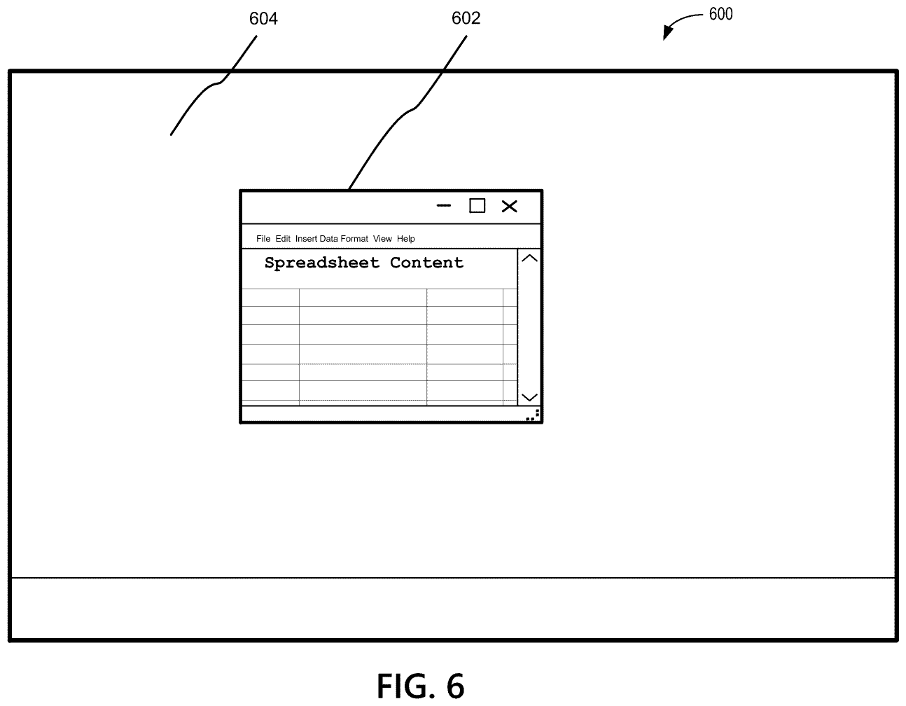

The shared content indicator 506 may store shared content data that may be used to generate screen data associated with a representation of the presenter screen comprising the content 502 and a masked version of the presenter screen 500 in which only the content 502 is visible and other regions of the presenter screen 500 are covered. For example, the content 502 may be visible within the presenter screen 500 and the audience screen 600 depicted in FIG. 6. The content 504, the shared content indicator 506, and the application icons 508-536 may remain visible in the presenter screen 500 but may not be visible in the audience screen 600 that is generated based on the screen data. In the regions of the presenter screen 500 that are not occupied by the content 502, the screen data may indicate regions of an audience screen that may be covered by a mask comprising a blurred rendering of those regions, a solid color (e.g., solid black), or a pattern (e.g., a crisscross pattern). By way of example, the screen data may comprise a bitmap of the presenter screen 500 and indications of the portions of the bitmap that may be masked.

FIG. 6 depicts an example of implementing a dynamic content sharing system in accordance with the present disclosure. The applications and operations described herein may be implemented or performed, for example, by one or more of the systems discussed with respect to FIGS. 1-4. The audience screen 600 may comprise the content 602 (e.g., a spreadsheet window). The audience screen 600 may be implemented on a local computing device of an audience member or a virtual desktop that is remote from the local computing device of the audience member. For example, the audience screen 600 may be accessed via a client application that is executed on a local computing device of the audience member. The client application may be configured to receive the content of the audience screen 600 via a collaboration application (e.g., a screen sharing application). For example, the audience screen 600 may be based on the screen data associated with the presenter screen 500 shown in FIG. 5. Further, the dimensions of the audience screen 600 may match the dimensions of the presenter screen 500. The audience screen may comprise the content 602 which may be based on the content 502 in the presenter screen 500. Further, the audience screen 600 may comprise only the content 602 and none of the regions of the presenter screen 500 that were not occupied by the content 502. In the regions of the audience screen 600 that are not occupied by the content 602, the audience screen may comprise a mask 604 (e.g., the vertical lines depicted in FIG. 6) that covers the regions of the presenter screen 500 that are not occupied by the content 602.

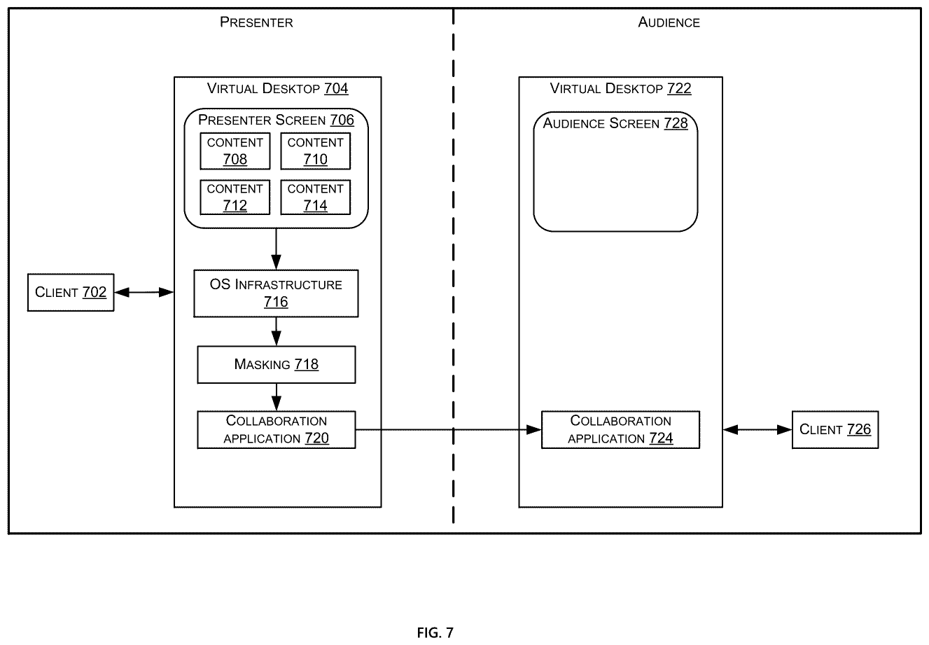

FIG. 7 depicts a platform architecture for a dynamic content sharing system that may be used in accordance with one or more aspects described herein. The applications and operations described herein may be implemented or performed, for example, by one or more of the systems discussed with respect to FIGS. 1-4. The devices and/or applications may operate in a networked environment, for example, transferring data over networks such as the computer network 230 (e.g., the Internet). It will be appreciated that the network connections shown are illustrative and other means of establishing a communications link between the devices may be used.

FIG. 7 illustrates an example of dynamic content sharing in which a client 702 and virtual desktop 704 that are used by a presenter (e.g., a presenter that is sharing content from a screen) may share content with a virtual desktop 722 and client 726 that are accessed by an audience (e.g., one or more participants of a screen sharing session). The client 702 may be used to select the content 708 (e.g., a window of a spreadsheet application) that is in the presenter screen 706 of the virtual desktop 704. Of the content 708-714 that is in the presenter screen 706, the content 708 may be selected for sharing based on an input in which the content 708 is associated with a shared content indicator of the presenter screen 706. When the content 708 is associated with the shared content indicator, shared content data comprising a list of the shared content may be generated. The shared content data may be used when screen data comprising a representation of the presenter screen 706 is generated. Further, the shared content data may be used to determine the regions of the presenter screen 706 that may be masked before the screen data is transmitted to the collaboration application 720.

The presenter screen 706 may then be processed by the OS infrastructure 716 which may use functions (e.g., built in functions configured to capture the contents of the presenter screen 706) of the operating system to generate screen data corresponding to the presenter screen 706. The screen data may then be transmitted to the masking application 718 which may access the shared content data to determine which regions of the screen capture of the presenter screen 706 to mask and which regions of the presenter screen not to mask (e.g., the region of the screen capture that are occupied by the content 708).

The masking application 718 may generate a screen data that includes a representation of the content 708 and covers the other regions of the screen capture of the presenter screen 706 that are not occupied by the content 708. For example, the masking application 718 may mask the regions of the screen capture not occupied by the content 708 by blurring the regions or rendering a solid background (e.g., a black background) in those regions. The screen data may then be transmitted to the collaboration application 720. The collaboration application 720 (e.g., an online meeting application or a screen sharing application) may be configured to share content based on the screen data (e.g., windows, documents, images, and/or other content within the presenter screen) with the collaboration application 724 which is being executed within the virtual desktop 722. The client 726 may access the collaboration application 724 via the virtual desktop 722. The collaboration application 724 may use the screen data to generate the audience screen 728 which displays the content 708 (e.g., the spreadsheet) which is visible and the remaining regions of the presenter screen 706, which are covered by the mask generated in by the masking application 718.

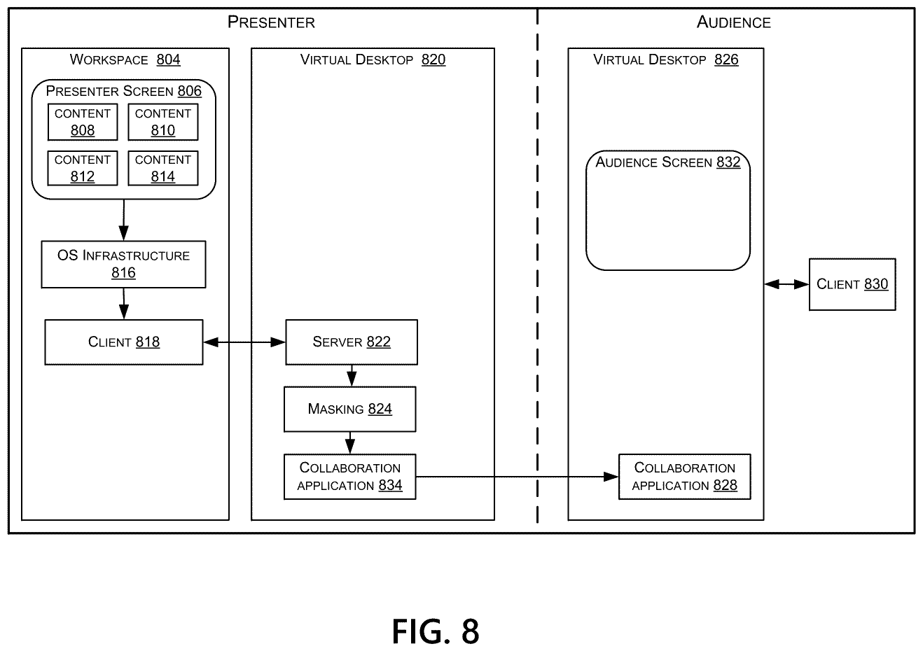

FIG. 8 depicts a platform architecture for a dynamic content sharing system that may be used in accordance with one or more aspects described herein. The applications and operations described herein may be implemented or performed, for example, by one or more of the systems discussed with respect to FIGS. 1-4. The devices and/or applications may operate in a networked environment, for example, transferring data over networks such as the computer network 230 (e.g., the Internet). It will be appreciated that the network connections shown are illustrative and other means of establishing a communications link between the devices may be used.

In this example, a presenter may use a workspace 804 that is implemented locally on a computing device of the presenter. The content 810-814 (e.g., three windows representing instances of a document viewing application) may be selected from the presenter screen 806 of the workspace 804. The content 810-814 may be selected for sharing based on an input in which an application icon associated with an application corresponding to the content 810-814 is associated with a shared content indicator that is rendered on the presenter screen 806. Further, the shared content indicator may comprise indications of shared content data comprising a list of the content 810-814. The shared content data may be accessed and used to generate screen data. Further, the shared content data may be used to determine the regions of the presenter screen 806 that may be masked before the screen data is transmitted from the collaboration application 834 of the virtual desktop 820 to the collaboration application 828 of the virtual desktop 826. The presenter screen 806 may then be processed by the OS infrastructure 816 to generate screen data associated with the presenter screen 806 and the shared content data.

A server 822 may be executed on the virtual desktop 820 and configured to receive the screen data from the client 818. The server 822 may then transmit the screen data to the masking application 824. The masking application 824 may access the shared content data to determine which regions of the presenter screen 806 to mask and which regions of the presenter screen not to mask (e.g., the regions of the presenter screen 806 occupied by the content 810-814). Further, the masking application 824 may generate screen data (e.g., covered screen data) that includes the content 810-814 and covers the other regions of the screen capture of the presenter screen 806 that are not occupied by the content 810-814. For example, the masking application 824 may mask the regions of the screen capture not occupied by the content 810-814.

The screen data may then be transmitted to the collaboration application 834. The collaboration application 834 may share content based on the screen data (e.g., the content 810-814) with the collaboration application 828 which is being executed within the virtual desktop 826. The client 830, which may be associated with an audience, may access the collaboration application 828 via the virtual desktop 826. The collaboration application 828 may then use the screen data to generate an audience screen 832 that displays the content 810-814 which is visible and a mask that covers the remaining regions of the presenter screen 806 that were represented in the screen data.

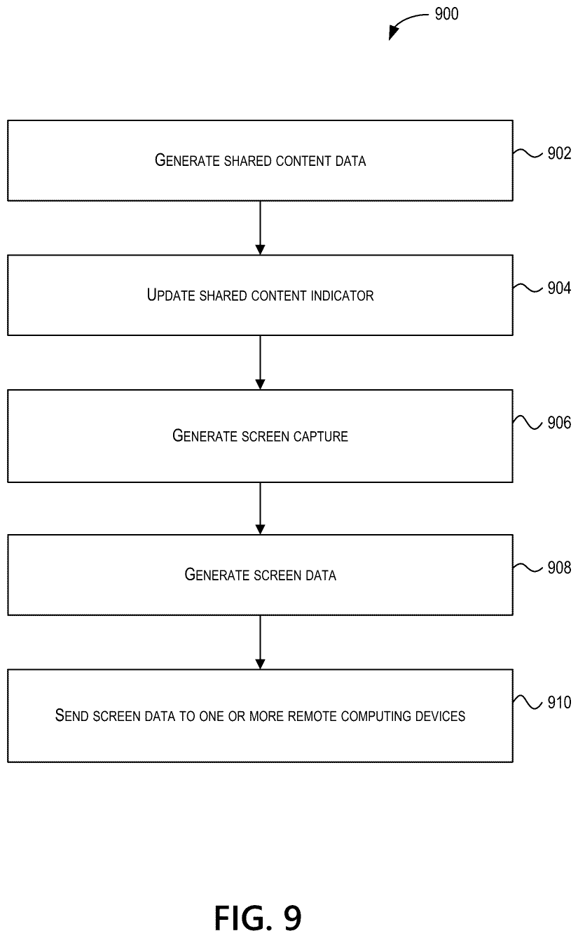

FIG. 9 depicts a flowchart showing an example method for sharing screen content in some implementations. The method may be implemented or performed, for example, by one or more of the systems as discussed with respect to FIGS. 1-4. The method may be implemented or performed, for example, by one or more computing devices and/or computing systems. For example, the method may be implemented by the one or more servers 206 or the one or more client devices 240 which are depicted in FIG. 2. The steps of the method may be described as being performed by particular components and/or computing devices for the sake of simplicity, but the steps may be performed by any component and/or computing device, or by any combination of one or more components and/or one or more computing devices. Further, the steps of the method may correspond to a set of instructions of an algorithm. By way of example, the algorithm implemented by the method may be used to perform operations including processing data, performing calculations, and/or determining solutions to computational problems. The steps of the method may be performed by a single computing device or by multiple computing devices. One or more steps of the method may be omitted, added, rearranged, and/or otherwise modified.

At step 902, a computing device may generate shared content data associated with sharing one or more portions of content. Generating shared content data may be based on receiving input associated with sharing one or more portions of content displayed on a presenter screen. For example, a presenter screen may comprise content represented as two windows in the presenter screen that correspond to instances of a word processing application. The content comprising the two windows may comprise documents that may be shared via a screen sharing application. An input associated with sharing the content comprising the two windows may be received in the form of clicking (e.g., with a mouse pointer) or touching (e.g., on a touchscreen) each window and dragging the windows to a shared content indicator window that is associated with the shared content data. The content added to the shared content data may comprise applications, windows, documents, images, and/or video. For example, a document may be dragged into a shared content indicator associated with the shared content data in order to share the document.

The input associated with sharing content displayed on a presenter screen may comprise dragging the one or more portions of content into the shared content indicator. For example, content may be dragged until a portion of the content contacts and/or overlaps a portion of the shared content indicator (e.g., a shared content window). When the content contacts and/or overlaps the shared content indicator, the content may be added to the shared content data. In some implementations, the input associated with sharing content may comprise selection of one or more portions of content by clicking on content within the presenter screen or selecting a region around each portion of the content.

The input associated with sharing content displayed on a presenter screen may comprise adding one or more application icons corresponding to the one or more portions of content to the shared content indicator. For example, an application icon may be dragged until a portion of the application icon contacts a portion of the shared content indicator. When the application icon contacts the shared content indicator, representations of content (e.g., icons or miniature versions of the content) corresponding to instances of the application associated with the application icon may be added to the shared content indicator.

The presenter screen may be generated by a virtual sharing application executed on another computing device (e.g., a virtualization system). For example, a client application implemented on the computing device of a presenter may be used to access a virtual desktop that is implemented on a virtualization system (e.g., a virtualization server) that executes an instance of the virtual desktop and associated applications. Further, the presenter screen may be generated within the virtual desktop generated by the virtual sharing application.

At step 904, the computing device may update a shared content indicator to indicate the one or more portions of content to share. Updating the shared content indicator may be based on the shared content data. For example, when content is added or removed, the shared content indicator may change to reflect the one or more portions of content that are currently being shared.

In some embodiments, a shared content indicator associated with the shared content data may comprise indications associated with the content that is shared. For example, the shared content data may comprise information associated with the application and/or file names associated with the one or more portions of content. The shared content indicator may in turn display a list including the applications and/or file names inside the shared content indicator.

Furthermore, the shared content indicator may comprise a window comprising one or more icons associated with the one or more portions of content. For example, the shared content indicator may comprise a window of a graphical user interface rendered on the presenter screen. If the one or more portions of content comprise two documents, the window may comprise two icons corresponding to the two documents and thereby indicate that two portions of content are being shared.

At step 906, the computing device may generate a screen capture based on the presenter screen. For example, the computing device may access a screen buffer that comprises information associated with an image displayed on the presenter screen. The computing device may then use the information from the screen buffer to generate the screen capture. In some embodiments, the screen capture may comprise a bitmap.

At least a portion of each of the one or more portions of content may be visible within the screen capture. For example, the computing device may determine one or more positions for the one or more portions of content such that when two portions of content comprising a small window and a larger window overlap, the smaller window is not completely covered by the larger window and at least a portion of each of the windows may be represented as visible within an audience screen. The computing device may then move and/or resize content so that at least a portion of each portion of the content is visible. For example, if a larger portion of content completely covers a smaller portion of content, the smaller content may be moved so that at least some of the smaller content is visible or the smaller content may be brought to the foreground so that the smaller content is visible above the larger portion of content.

At step 908, the computing device may generate screen data. The screen data may indicate the one or more portions of content and/or a mask that covers regions of the screen capture that are not occupied by the one or more portions of content that are shared. The mask may for example cover a desktop occupies regions around one or more portions of content that are being shared. The computing device may determine the regions of the screen capture that are not occupied by the content. In some embodiments, the mask may comprise a blurred image based on the regions of the screen capture that are not occupied by the one or more portions of content that are shared. For example, the mask may apply a Gaussian blur to the regions of the screen capture that are not occupied by the content that is shared. The Gaussian blur may obfuscate the regions of the screen capture that are not occupied by the one or more portions of content and make any written content completely illegible. Further, the mask may comprise any combination of a solid color (e.g., a black or blue mask) and/or a pattern that covers the screen capture.

The screen data may indicate positions of the one or more portions of content within the screen capture of the presenter screen. For example, the computing device may generate each the content that is shared at the respective plurality of positions corresponding to the content that is shared. The screen data may comprise a bitmap representation of the content at the plurality of positions within the screen capture.

Generating the screen data may comprise determining one or more positions, within a screen capture of the presenter screen, in which to generate the one or more portions of content. For example, the computing device may determine positions to place the content within a screen capture that may be used as the basis for an audience screen that is displayed (e.g., the audience screen 728). Further, the computing device may determine positions of the content in relation to other content within the screen capture. For example, the computing device may determine that certain content may be adjacent to other content or separated by a certain amount of space if the space is available.

The one or more positions of the content within the screen capture may correspond to a one or more positions of the content within the presenter screen. For example, if the content are at particular coordinates (e.g., x and y coordinates corresponding to horizontal and vertical positions within the presenter screen) within the presenter screen, the one or more positions of the content within the screen capture may correspond to those particular coordinates.

The one or more positions of the content may be based on dimensions of the content. For example, the computing device may determine dimensions of each portion of the content and determine a one or more positions for the content such that the entirety of each portion of the content is visible within one or more audience screens. Content that is determined to be at least partially outside the boundaries of the audience screen may be shifted and/or resized until the content fits within the dimensions of the audience screen.

An overlap of each portion of the content with respect to other portions of the content may be based on an order in which each portion of the content was selected for sharing. For example, input associated with sharing one or more portions of content comprising three windows is received, a first portion of content that was selected first may be overlapped by a second portion of content that was selected second, and the second portion of content may be overlapped by a third portion of content that was selected third. In this way, more recently selected portions of content may overlap less recently selected portions of content. Further, a portion of the content that was most recently added to the shared content data may overlap other portions of the content when generated within an audience screen.

At step 910, the computing device may send the screen data to one or more computing devices. The one or more computing devices may include one or more remote computing devices and/or one or more local computing devices. The one or more computing devices may be configured to generate one or more audience screens based on the screen data.

For example, the computing device may send data including the screen data to one or more remote computing devices via a communications network (e.g., the network 101). The one or more remote computing device may then use the screen data to display (on one or more audience screens) the content that is displayed within the presenter screen. Further, the screen data may indicate the regions of the screen capture that are covered by the mask. By way of further example, the mask may comprise an image of the screen capture not occupied by the one or more portions of content.

In some embodiments, the computing device may send the screen data via one or more collaboration applications executed on the computing device. Further, one or more instances of the one or more collaboration applications may be executed on the one or more remote computing devices. For example, the computing device may execute a collaboration application that is used to share the presenters screen. The computing device may send the screen data to the collaboration application which may in turn send the screen data to the one or more remote computing devices, each of which is also executing an instance of the collaboration application.

Dimensions of the audience screen may correspond to dimensions of the presenter screen. For example, if the presenter screen has a resolution of 3840 pixels by 2160 pixels, the screen capture may also have a resolution of 3840 pixels by 2160 pixels. In some embodiments, the dimensions of the screen capture may be increased or decreased to match the dimensions of the presenter screen.

The screen data may be sent to one or more remote computing devices on a real-time or near real-time basis. For example, the screen data may be updated based on the state of the presenter screen. Further, the screen data may be updated in real time or when the presenter screen has changed (e.g., when content has been added, removed, or moved).

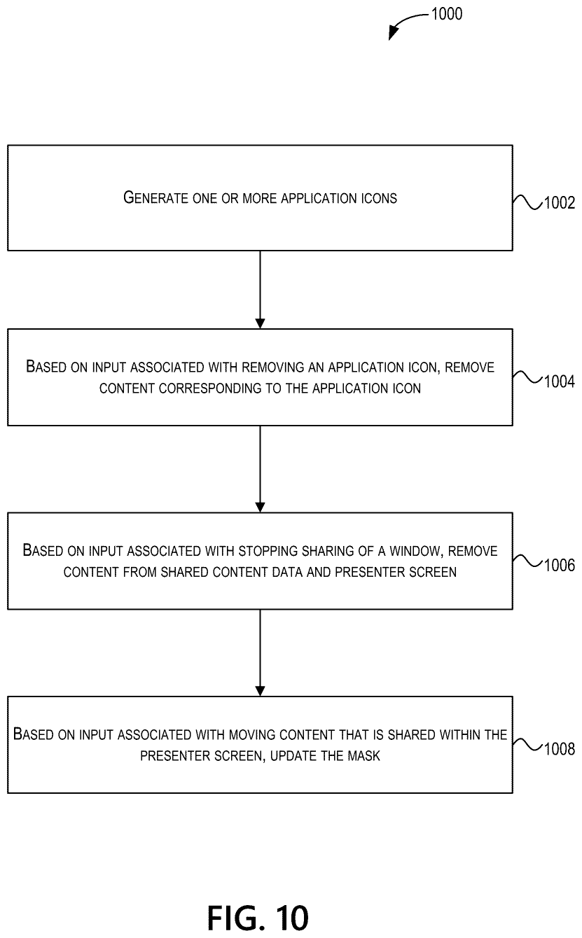

FIG. 10 depicts a flowchart showing an example method for dynamic content sharing in some implementations. The method may be implemented or performed, for example, by one or more of the systems as discussed with respect to FIGS. 1-4. The method may be implemented or performed, for example, by one or more computing devices and/or computing systems. For example, the method may be implemented by the one or more servers 206 or the one or more client devices 240 which are depicted in FIG. 2. The steps of the method may be described as being performed by particular components and/or computing devices for the sake of simplicity, but the steps may be performed by any component and/or computing device, or by any combination of one or more components and/or one or more computing devices. Further, the steps of the method may correspond to a set of instructions of an algorithm. By way of example, the algorithm implemented by the method may be used to perform operations including processing data, performing calculations, and/or determining solutions to computational problems. The steps of the method may be performed by a single computing device or by multiple computing devices. One or more steps of the method may be omitted, added, rearranged, and/or otherwise modified.

At step 1002, a computing device may generate, within the shared content indicator (e.g., a window rendered on the presenter screen), one or more application icons corresponding to one or more applications that execute applications associated with the one or more portions of content that are shared. For example, when content is shared, the computing device may determine an application associated with the content and generate an application icon corresponding to the application within the shared content indicator. The application icons within the shared content indicator may provide an indication of the application content that is being shared.

At step 1004, a computing device may, based on receiving input associated with removing an application icon associated with one or more portions of content from the shared content indicator, remove one or more portions of content corresponding to the application icon from the presenter screen. For example, when there is a wish to stop sharing content associated with an application, an application icon corresponding to the content and within the shared content indicator (e.g., an application icon corresponding to a window that is being shared) may be dragged from the shared content indicator. When the application icon is removed from the shared content indicator, the one or more portions of content may be removed from the presenter screen. The region previously occupied by the content removed from the presenter screen may be covered with a mask such that the content is no longer visible.

At step 1006, a computing device may, based on receiving input associated with stopping the sharing of content, remove the one or more portions of content from the shared content data and the presenter screen. For example, some portion of the presenter screen may comprise an interface that is configured to receive an input to remove content from the presenter screen. The interface may, for example, comprise a list of names of the content that is being shared and content may be removed from the presenter screen by clicking on the name associated with the content. Further, the shared content data may be updated to indicate the portion of content that is no longer being shared and the shared content indicator may also be updated to indicate the removal of the portion of content that is not longer being shared (e.g., the portion of content that was removed may no longer be indicated in the shared content indicator).

At step 1008, a computing device may, based on receiving input associated with moving one or more portions of content that are shared within the presenter screen, update the mask to cover the regions of the audience screen that were previously occupied by the one or more portions of content that are shared. For example, the screen data may be updated (e.g., updated when content is shared or unshared; or updated on a real time or near-real time basis) to correspond to the state of the presenter screen and the content that is being shared. When content that was previously shared is unshared, the region of an audience screen corresponding to the region of the presenter screen that was previously occupied by the content may be masked so that the unshared content is covered and thereby hidden from view.

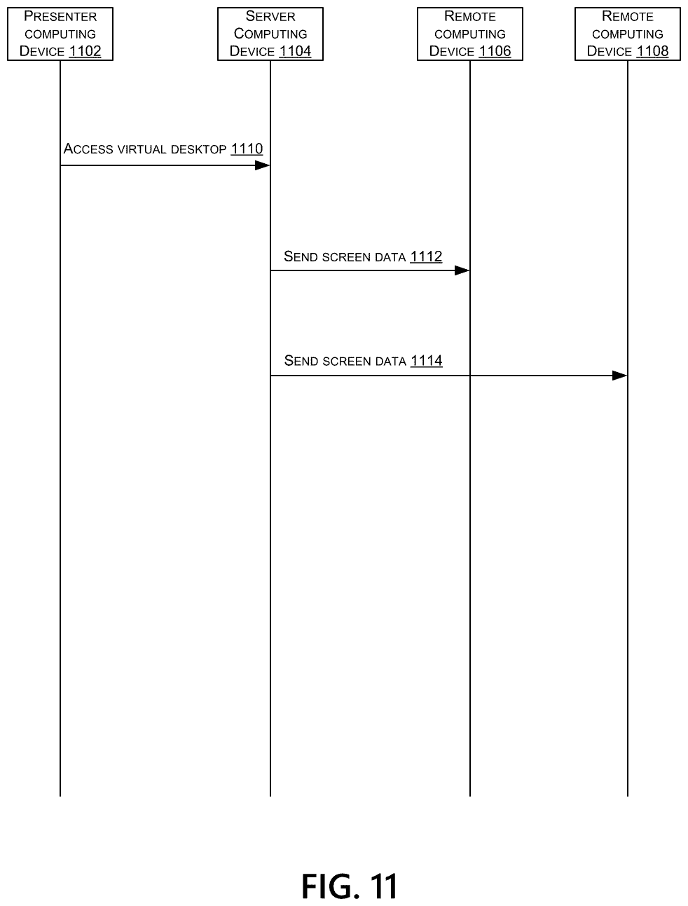

FIG. 11 depicts a schematic representation of transmitting screen data between devices. The operations depicted in FIG. 11 may be implemented or performed, for example, by one or more of the systems as discussed with respect to FIGS. 1-4. The presenter computing device 1102, the server computing device 1104, a remote computing device 1106, and a remote computing device 1108 may be configured to transmit and/or receive screen data. Further, one or more steps and/or one or more operations may be omitted, added, rearranged, and/or otherwise modified.

At step 1110, the presenter computing device 1102 may execute a client application that may be used to access a virtual desktop application that is executed on the server computing device 1104. The presenter computing device 1102 may communicate with the server computing device 1104 and control applications that operate within the virtual desktop application executed on the server computing device 1104. Further, the presenter computing device 1102 may use the client application to share content via a collaboration application that is executed within the virtual desktop of the server computing device 1104. For example, the client application may be used to send screen data comprising information associated with windows, documents, images, and/or video that may be provided on a presenter screen generated within the virtual desktop executing on the server computing device 1104. Further, the screen data may be based in part on content from the presenter screen that is designated for sharing and a mask that covers any portion of the presenter screen that is not occupied by the content designated for sharing. The screen data may indicate content displayed on the presenter screen and a mask that covers regions of the presenter screen that do not comprise the shared content.

At step 1112, the server computing device 1104 may send screen data to the remote computing device 1106. Further, at step 1114 the server computing device 1104 may send the screen data to the remote computing device 1108. The screen data sent to the remote computing device 1106 and the remote computing device 1108 may include information associated with the content and the mask indicating regions of the presenter screen on the presenter computing device 1102 that are covered and not shared with the remote computing device 1106 and the remote computing device 1108. The remote computing device 1106 and the remote computing device 1108 may be associated with an audience that uses a collaboration application that may receive the screen data to display the contents of the screen data on audience screens that may be viewed on display devices of the remote computing device 1106 and the remote computing device 1108.

The following paragraphs (M1) through (M16) describe examples of methods that may be implemented in accordance with the present disclosure.

(M1) A method comprising: based on receiving input associated with sharing one or more portions of content displayed on a presenter screen, generating, by a computing device, shared content data associated with sharing the one or more portions of content; updating, by the computing device, based on the shared content data, a shared content indicator to indicate the one or more portions of content to share; generating, by the computing device, a screen capture based on the presenter screen; generating, by the computing device, screen data comprising the one or more portions of content and a mask that covers regions of the screen capture that are not occupied by the one or more portions of content; and sending, by the computing device, the screen data to one or more remote computing devices that are configured to generate one or more audience screens based on the screen data.

(M2) A method may be performed as described in paragraph (M1) wherein the screen data is sent via an instance of a collaboration application executed on the computing device, and wherein one or more instances of the collaboration application are executed on the one or more remote computing devices.

(M3) A method may be performed as described in any of paragraphs (M1) through (M2) wherein one or more positions of the one or more portions of content within the screen capture correspond to one or more positions of the one or more portions of content within the presenter screen.

(M4) A method may be performed as described in any of paragraphs (M1) through (M3) wherein an overlap of each portion of the content with respect to other portions of the content is based on an order in which each portion of the content was selected for sharing.

(M5) A method may be performed as described in any of paragraphs (M1) through (M4) wherein a portion of content that was most recently added to the shared content data overlaps other portions of the content within the screen capture.

(M6) A method may be performed as described in any of paragraphs (M1) through (M5) wherein the shared content indicator comprises a window comprising one or more icons associated with the one or more portions of content.

(M7) A method may be performed as described in any of paragraphs (M1) through (M6) wherein the input associated with sharing content displayed on a presenter screen comprises: dragging each portion of the content into the shared content indicator.

(M8) A method may be performed as described in any of paragraphs (M1) through (M7) wherein the input associated with sharing content displayed on a presenter screen comprises: adding one or more application icons corresponding to the one or more portions of content to the shared content indicator.

(M9) A method may be performed as described in any of paragraphs (M1) through (M8) further comprising: generating, within the shared content indicator, one or more application icons corresponding to one or more applications that execute applications associated with the one or more portions of content that are shared.

(M10) A method may be performed as described in any of paragraphs (M1) through (M9) based on receiving input associated with removing an application icon associated with one or more portions of content from the shared content indicator, removing the one or more portions of content from the presenter screen.

(M11) A method may be performed as described in any of paragraphs (M1) through (M10) wherein dimensions of at least one of the one or more audience screens correspond to dimensions of the presenter screen.

(M12) A method may be performed as described in any of paragraphs (M1) through (M11) wherein the screen data indicates where to mask regions of the screen capture that are not occupied by the one or more portions of content that are shared.

(M13) A method may be performed as described in any of paragraphs (M1) through (M12) wherein the presenter screen is generated by a virtual sharing application executed on a virtualization system.

(M14) A method may be performed as described in any of paragraphs (M1) through (M13) wherein one or more positions of the one or more portions of content are based on dimensions of the one or more portions of content.

(M15) A method may be performed as described in any of paragraphs (M1) through (M14) further comprising: based on receiving input associated with stopping the sharing of one or more portions of content, removing the one or more portions of content from the shared content data and the presenter screen.

(M16) A method may be performed as described in any of paragraphs (M1) through (M15) further comprising: based on receiving input associated with moving content that is shared within the presenter screen, updating the mask to cover the regions of the screen capture that were previously occupied by the one or more portions of content that are shared.

(M17) A method may be performed as described in any of paragraphs (M1) through (M16) wherein the mask comprises a blurred image based on the regions of the screen capture that are not occupied by the one or more portions of content.

(M18) A method may be performed as described in any of paragraphs (M1) through (M17) wherein the shared content indicator comprises a window comprising a list of content based on the one or more portions of content.

The following paragraph (A1) describes examples of apparatuses or devices that may be implemented in accordance with the present disclosure.

(A1) A computing device comprising: one or more processors; and memory storing instructions that, when executed by the one or more processors, cause the computing device to: based on receiving input associated with sharing one or more portions of content displayed on a presenter screen, generate shared content data associated with sharing the one or more portions of content; update, based on the shared content data, a shared content indicator to indicate the one or more portions of content to share; generate a screen capture based on the presenter screen; generate screen data comprising the one or more portions of content and a mask that covers regions of the screen capture that are not occupied by the one or more portions of content; and send the screen data to one or more remote computing devices that are configured to generate one or more audience screens based on the screen data.

The following paragraph (CRM1) describes examples of computer-readable media that may be implemented in accordance with the present disclosure.

(CRM1) One or more non-transitory computer-readable media storing instructions that, when executed, cause a computing device to: based on receiving input associated with sharing one or more portions of content displayed on a presenter screen, generate shared content data associated with sharing the one or more portions of content; update, based on the shared content data, a shared content indicator to indicate the one or more portions of content to share; generate a screen capture based on the presenter screen; generate screen data comprising the one or more portions of content and a mask that covers regions of the screen capture that are not occupied by the one or more portions of content; and send the screen data to one or more remote computing devices that are configured to generate one or more audience screens based on the screen data.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
based on receiving input associated with sharing one or more portions of content displayed on a presenter screen, generating, by a computing device, shared content data associated with sharing the one or more portions of content;
updating, by the computing device, based on the shared content data, a shared content indicator to indicate the one or more portions of content to share;
generating, by the computing device, a screen capture based on the presenter screen;
generating, by the computing device, screen data comprising the one or more portions of content and a mask that covers regions of the screen capture that are not occupied by the one or more portions of content; and
sending, by the computing device, the screen data to one or more remote computing devices that are configured to generate one or more audience screens based on the screen data.

2. The method of claim 1, wherein the screen data is sent via an instance of a collaboration application executed on the computing device, and wherein one or more instances of the collaboration application are executed on the one or more remote computing devices.

3. The method of claim 1, wherein one or more positions of the one or more portions of content within the screen capture correspond to one or more positions of the one or more portions of content within the presenter screen.

4. The method of claim 1, wherein an overlap of each portion of the one or more portions of content with respect to other portions of the one or more portions of content is based on an order in which each portion of the content was selected for sharing.

5. The method of claim 1, wherein a portion of content that was most recently added to the shared content data overlaps other portions of the content within the screen capture.

6. The method of claim 1, wherein the shared content indicator comprises a window comprising one or more icons associated with the one or more portions of content.

7. The method of claim 1, wherein the input associated with sharing one or more portions of content displayed on a presenter screen comprises:
dragging the one or more portions of content into the shared content indicator.

8. The method of claim 1, wherein the input associated with sharing one or more portions of content displayed on a presenter screen comprises:
adding one or more application icons corresponding to the one or more portions of content to the shared content indicator.

9. The method of claim 1, further comprising:
generating, within the shared content indicator, one or more application icons corresponding to one or more applications that execute applications associated with the one or more portions of content that are shared.

10. The method of claim 1, further comprising:
based on receiving input associated with removing an application icon associated with one or more portions of content from the shared content indicator, removing the one or more portions of content from the presenter screen.

11. The method of claim 1, wherein dimensions of at least one of the one or more audience screens correspond to dimensions of the presenter screen.

12. The method of claim 1, wherein the screen data indicates where to mask regions of the screen capture that are not occupied by the one or more portions of content that are shared.

13. The method of claim 1, wherein the presenter screen is generated by a virtual sharing application executed on a virtualization system.

14. The method of claim 1, wherein one or more positions of the one or more portions of content are based on dimensions of the one or more portions of content.

15. The method of claim 1, further comprising:
based on receiving input associated with stopping sharing of one or more portions of content, removing the one or more portions of content from the shared content data and the presenter screen.

16. The method of claim 1, further comprising:
based on receiving input associated with moving content that is shared within the presenter screen, updating the mask to cover the regions of the screen capture that were previously occupied by the one or more portions of content that are shared.

17. The method of claim 1, wherein the mask comprises a blurred image based on the regions of the screen capture that are not occupied by the one or more portions of content.

18. The method of claim 1, wherein the shared content indicator comprises a window comprising a list of content based on the one or more portions of content.

19. A computing device comprising:
one or more processors; and
memory storing instructions that, when executed by the one or more processors, cause the computing device to:
based on receiving input associated with sharing one or more portions of content displayed on a presenter screen, generate shared content data associated with sharing the one or more portions of content;
update, based on the shared content data, a shared content indicator to indicate the one or more portions of content to share;
generate a screen capture based on the presenter screen;
generate screen data comprising the one or more portions of content and a mask that covers regions of the screen capture that are not occupied by the one or more portions of content; and
send the screen data to one or more remote computing devices that are configured to generate one or more audience screens based on the screen data.

20. One or more non-transitory computer-readable media storing instructions that, when executed, cause a computing device to:
based on receiving input associated with sharing one or more portions of content displayed on a presenter screen, generate shared content data associated with sharing the one or more portions of content;
update, based on the shared content data, a shared content indicator to indicate the one or more portions of content to share;
generate a screen capture based on the presenter screen;
generate screen data comprising the one or more portions of content and a mask that covers regions of the screen capture that are not occupied by the one or more portions of content; and
send the screen data to one or more remote computing devices that are configured to generate one or more audience screens based on the screen data.
